(19) United States
(12) Patent Application Publication
(10) Pub. No.: US 2007/0011173 A1
(43) Pub. Date: Jan. 11, 2007

(54) METHOD AND APPARATUS FOR PROVIDING SHOE RECOMMENDATIONS

(75) Inventor: Val Agostino, Houston, TX (US)

Correspondence Address: SHERIDAN ROSS PC, 1560 BROADWAY, SUITE 1200, DENVER, CO, 80202, US

(73) Assignee: EBAGS.COM, Greenwood Village, CO (US)

(21) Appl. No.: 11/419,967

(22) Filed: May 23, 2006

Related U.S. Application Data
(60) Provisional application No. 60/684,149, filed on May 23, 2005.

(51) Int. Cl. G06F 17/30

(52) U.S. Cl. 707/10

(57) ABSTRACT

The present invention is directed to computer method and apparatus for providing a recommended shoe for an individual by obtaining a personalized shoe profile and providing one or more shoe recommendations that correspond to the individual's shoe profile. The present invention is particularly suitable for the online purchasing of shoes wherein through obtaining a virtual shoe profile from an individual, a plurality of recommended shoes can be displayed for the user for purchase based upon the individual's shoe profile.

### CROSS REFERENCE TO RELATED APPLICATIONS

This Application claims the benefit of U.S. Provisional Application No. 60/684,149, filed May 23, 2005, the entire disclosure of which is hereby incorporated herein by reference.

### FIELD OF INVENTION

The present invention relates to a computer method and apparatus for providing a recommended shoe for an individual, and more particularly to a computer method and apparatus for providing a recommended shoe for an individual comprising obtaining a personalized shoe profile from an individual and providing one or more shoe recommendations that correspond to the individual's shoe profile.

### BACKGROUND OF INVENTION

When shopping online, products for sale must necessarily be represented by pictures, icons, or textural descriptions. For example, a website that sells shoes may use digital photographs of shoes so that a customer can see the appearance of the shoes. However, because customers are not able to physically try on the shoes to determine if the shoes have the desired fit, customers often visit traditional “brick and mortar” stores over shopping online. Such customers frequently do not wish to deal with the hassle of returning shoes that do not fit, or otherwise do not wish to purchase the same shoe in multiple sizes knowing they will have to return at least one pair.

Further contributing to the difficulty of buying shoes online, and shopping for shoes generally, is the fact that often one manufacturer's shoe size often does not correlate with another manufacturer's shoe size. Therefore, for example, a size “9” Nike® shoe may have a much different fit than an Adidas® size “9,” or other manufacturer's size “9.” For this reason also, customers often choose to buy shoes in person over buying shoes online. Additionally, such discrepancies between manufacturers also add to the amount of time spent by the average consumer trying on shoes in the typical “brick and mortar” store. Accordingly, there is a need to provide consumers with a method and apparatus for providing a recommended shoe selection or selection(s) that will match or substantially fit a particular individual's foot, particularly without the need to physically try on the shoe.

### SUMMARY

Accordingly, it is an object of the present invention to provide computer method and apparatus for providing a suitable shoe for an individual comprising obtaining a personalized shoe profile, and providing one or more shoes that are suitable for the individual's shoe profile. Typically, an individual shoe profile is provided by obtaining from an individual at least one of biographical data, shoe use and style preference data, a shoe history for the individual, and actual foot measurements for the person. Thereafter, an algorithm aggregates shoe profiles from more than one individual and physical shoe size data from various shoes on the market to provide at least one shoe recommendation that corresponds to the shoe profile of an individual. The present invention is particularly suitable for the online purchasing of shoes, wherein through developing a virtual shoe profile for an individual, one or more recommended shoe selections can be displayed for the user for purchase based upon the shoe profile created by or for the user.

### BRIEF DESCRIPTION OF THE DRAWINGS

FIG. 1 depicts an e-commerce system in accordance with embodiments of the present invention;

FIG. 2 depicts a method of creating a shoe recommendation in accordance with embodiments of the present invention;

FIG. 3 depicts a recommend shoe selection for an individual based on the shoe profile of the individual in accordance with embodiments of the present invention;

FIG. 4 depicts a method of creating a user profile in accordance with embodiments of the present invention;

FIG. 5 depicts a biological portion of an individual shoe profile in accordance with embodiments of the present invention;

FIG. 6 depicts a foot size measurement instruction sheet and foot measurement data entry portion of an individual shoe profile in accordance with embodiments of the present invention;

FIG. 7 depicts a method of creating a virtual closet in accordance with embodiments of the present invention;

FIG. 8 depicts a history portion of an individual shoe profile in accordance with embodiments of the present invention;

FIG. 9 depicts a substantially completed individual shoe profile in accordance with embodiments of the present invention;

FIG. 10 depicts a method of creating a purchase history for a user in accordance with embodiments of the present invention; and

FIG. 11 depicts a method of creating a size recommendation in accordance with embodiments of the present invention.

### DETAILED DESCRIPTION

The present invention is directed to a computer method and apparatus for providing a shoe recommendation for an individual comprising obtaining a personalized shoe profile and providing one or more recommended shoes, including a style and size of shoe, that corresponds to the individual's shoe profile. The term “shoe profile” as used herein refers to a compilation of at least one of biographical data, shoe use and style preference data, a shoe history for the individual, and actual foot measurements. The present invention is particularly suitable for the online purchasing of shoes wherein through developing a virtual shoe profile for an individual, one or more recommended shoe selections can be displayed for the user for purchase based upon the shoe profile provided by or for the user.

The obtaining of a shoe profile for an individual typically comprises collecting data related to the individual's feet and shoe preferences. The shoe profile information is preferably obtained by having an individual input data using any suitable input device known in the art, such as a keyboard, in communication with a suitable computing device known in the art. Alternatively, any of the shoe profile data be provided to a customer service representative or obtained by any other suitable method. The information requested from each individual may include the individual's personal information (i.e., age, gender, occupation, salary, lifestyle, residence location), shoe history, and foot measurements.

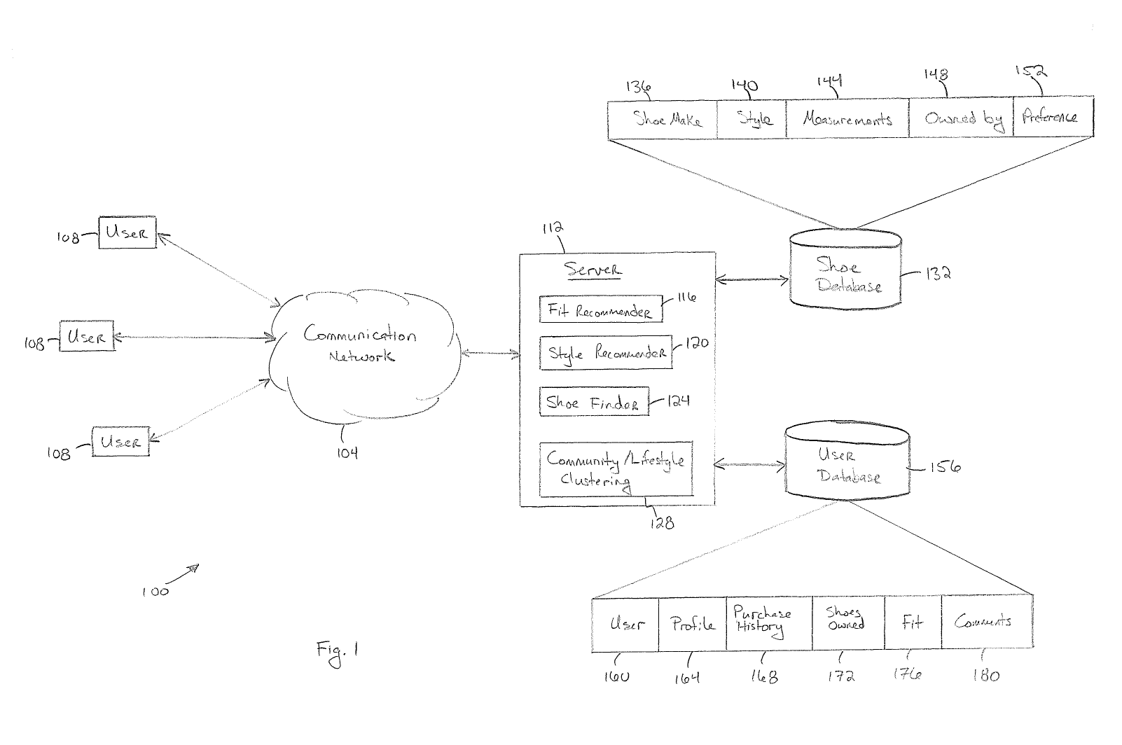

With reference initially to FIG. 1, a network 100 of shoppers will be discussed in accordance with embodiments of the present invention. A communication network 104 provides a plurality of users 108 communication capabilities with a server 112. The server 112 includes a fit recommender 116, a style recommender 120, a shoe finder 124, and a community/lifestyle clustering agent 128. The server 112 may be owned and/or operated by a corresponding online shopping provider or enterprise like a merchant of one type of item or a retailer who sells a number of different products and product lines. In accordance with one embodiment, the server 112 is owned and/or operated by a vendor specializing in the online sale of shoes and other accessories. The system 100 depicted comprises three user devices 108 for the purposes of illustration only. As can be appreciated by one of skill in the art, any number of user devices 108 may be connected to the server 112 via the communication network 104. Suitable examples of the communication network 104 include, but are not limited to, the Internet or an intranet (i.e., enterprise network). Furthermore, the connections between the user devices 108 and the network 104 can be either wired or wireless connections and communications between the user devices 108 and the network 104 can follow any known protocols, for example, Transmission Control Protocol/Internet Protocol (TCP/IP).

The server 112 may comprise capabilities of a web server, meaning that it can provide websites to a user based on requests received in the form of a URL or the like. Upon receipt of a request, the server 112 retrieves the website and provides a display of it's content to the user 108. The server 112 may further comprise the functionality of a processing or searching server. In other words, the server 112 can receive particular inputs and based on those inputs customize web content before it is provided to a user 108.

Examples of user devices 108 for interacting with server 112 include, without limitation, personal computers, laptop computers, notebook computers, palm top computers, network computers, or any processor-controlled device capable of executing a web browser or other type of application for interacting with the network 104.

The server 112 is connected to a shoe database 132 and a user database 156. Although depicted as separate databases, the shoe 132 and user 156 databases maybe maintained in a common database, directory, or memory on the server 112. The server 112 works cooperatively with the databases 123, 156 to provide users 108 with various recommendations related to shoes. Specifically, the fit recommender 116 is operable to receive user information, which may include identification information. If the user 108 is a subscriber and other information (i.e., bibliographic, shoe information, size, and the like) has already been recovered from the user, then the fit recommender 116 can reference the user database 156 and retrieve such information based on the user's 108 identity. In the event that the user 108 is not a subscriber, then the fit recommender 116 can request certain information from the user 108 to help determine what size of shoe might fit the user 108. Based on the user information, the fit recommender 116 references the shoe database 132 to determine what size of shoe the user 108 should wear. The shoe database 132 may contain information like various shoe makes 136, their corresponding style 140, internal measurements of the shoe 144 (i.e., length, width, arch support information, total support information, etc.), known owners of the shoe 148, and their preference rating of the shoe 152. Based on the attributes of the shoe, the fit recommender 116 can recommend a shoe size and/or model of shoe for a user 108.

The style recommender 120 is operable to identify a shoe profile of a user and make a reasonable guess as to what other shoes the user may enjoy. To accomplish this, the style recommender 120 receives information from the user 108 and analyzes the information to determine what preferences the user has. The style recommender 120 may also identify groups that the user 108 belongs to, and scan shoe styles that are popular in the group to come up with recommendations for the user 108. The style recommender 120 can generally determine what taste a user has based on information stored in the user database 156 (if the user is a subscriber and has information stored in the user database 156). Examples of information that may be stored in the user database 156 include, but are not limited to, user identity 160, profile 164 (e.g., bibliographic profile and shoe profile), shoe purchase history 168, shoes owned 172, fit preferences 176, and comments related to the shoes 180. By referencing at least a portion of information the style recommender 120 can identify what style the user 108 may prefer and provide shoe style recommendations. If the user chooses a specific shoe that the style recommender 120 has recommended, the fit recommender 116 will perform a fit analysis on the chosen shoe.

The shoe finder 124 is operable to search for specific shoes in the shoe database 132. A user 108 may designate a particular style of shoe that he/she would like to purchase and the shoe finder 124 can reference the shoe database 132 to determine what shoes exist that match the have the requested style. The shoe finder 124 may also show the user 108 different color choices for a particular type of shoe, or a number of different shoes from the same brand.

In the event that the user 108 wants shoe recommendations based on group preferences or based on his/her lifestyle, then the community/lifestyle clustering agent 128 is employed to create shoe recommendations. The community/lifestyle clustering agent 128 compares preferences of multiple users from the user database 156 to determine which users have matching profiles of the browsing user 108. A user 108 may be associated with a group based on a number of different parameters including, without limitation, age, gender, occupation, hobbies, interests, salary, and the like. U.S. patent application Ser. No. 11/256,655, filed on Oct. 20, 2005, the entire disclosure of which is hereby incorporated herein by reference, describes a method and system for grouping users based on interests and other profile parameters. Once a user has been grouped or otherwise associated with a community of users based on his/her preferences, the user may be provided shoe recommendations based on the community's feedback.

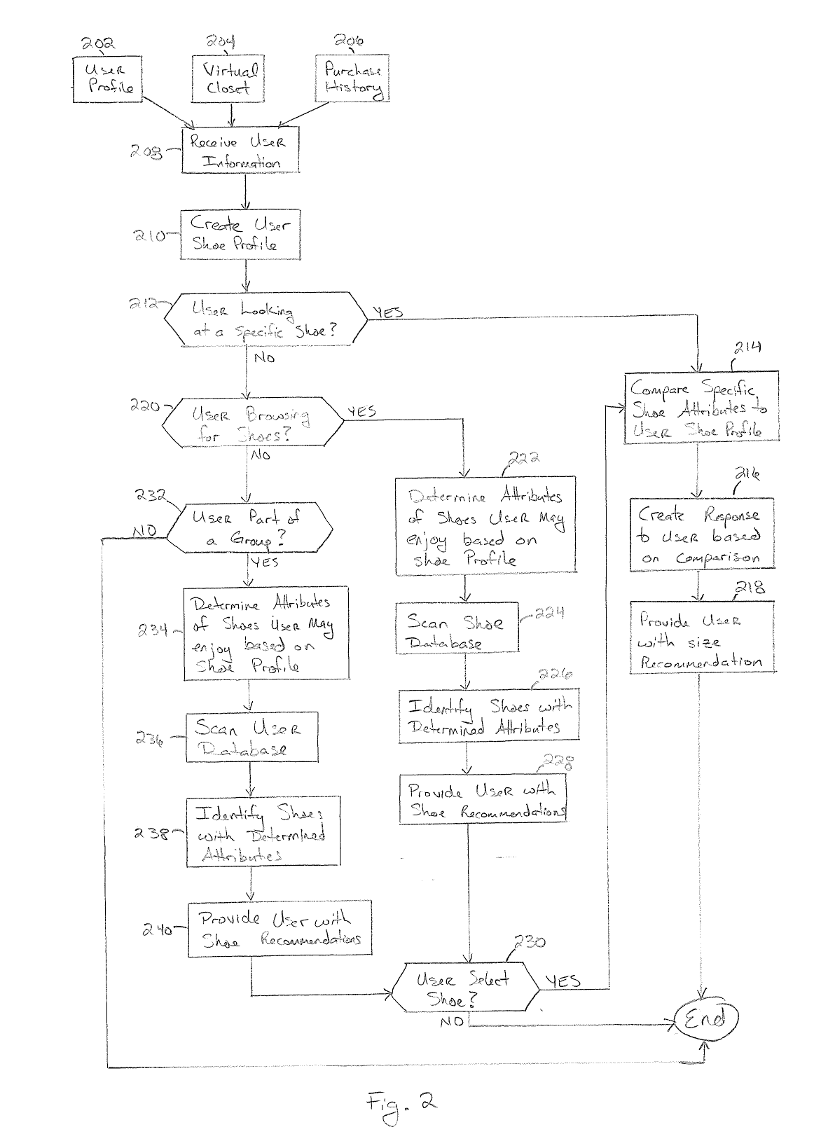

Referring now to FIG. 2, a method of providing a user 108 with recommendations will be described in accordance with at least some embodiments of the present invention. The method begins when one or more of a user profile (step 202), virtual closet (step 204), and purchase history (step 206) are input by the user 108. The user 108 information is received by the server 112 and either stored in the user database 156 or maintained in memory of the server 112 (step 208). Then the user 108 is allowed to browse the website by interacting with the server 112. When a suitable amount of user information has either been received from the user 108 or retrieved from the user database 156, the server 112 creates a user shoe profile (step 210). The user shoe profile may comprise bibliographical information including a user's physical features (e.g., weight, height, foot size, etc.), shoe information (e.g., shoes owned and shoes purchased through online vendor), and foot measurements.

In step 212 it is determined if the user is looking at a specific shoe, or is requesting a specific shoe. This decision may be determined by referencing the website that the user 108 is currently viewing and how the user 108 has interacted with the server 112 during a particular web session. If it is determined that the user 108 is looking for a specific shoe, the fit recommender 116 retrieves the subject shoe's attributes and compares those attributes with the user's shoe profile (step 214). The attributes of the shoe may include the inner length, inner width, heel width, support information, types of securing mechanisms (e.g., laces, straps, buckles, etc.), heel height if applicable, and other physical qualities of the shoe. Based on the comparison of the user's shoe profile with the shoe's attributes, the fit recommender 116 generates a response to the user 108 (step 216). The recommendation may include a range of sizes that the user may try or a particular size the user should purchase. The recommendation may also include color or material type recommendations based on the user's profile. Once the response has been created it is provided to the user 108 via the communication network 104 (step 218). The recommendation may be displayed to the user 108 on his/her display device either visually, audibly, or a combination thereof.

In the event that the user 108 was not looking at a specific shoe or had a specific shoe in mind, it is determined if the user is browsing for shoes (step 220). Generally, the fact that the user 108 is viewing web pages (somehow associated with shoes) from the server 112 provides an indication that the user 108 is browsing for shoes. If the user 108 is browsing through a number of different web pages associated with different shoes, it may be determined that the user 108 is browsing for shoes. Once it is determined that the user 108 is browsing for shoes, the style recommender 120 references the user's shoe profile to determine attributes of a shoe that the user may enjoy (step 222). The style recommender 120 may determine that a user 108 is active based on his/her shoe profile and therefore provide recommendations for sneakers or other types of active footwear. Alternatively, the style recommender 120 may determine that the user 108 lives in a high fashion urban area, the style recommender 120 may provide recommendations for more formal shoes and the like.

After at least some shoe attributes have been determined by the style recommender 120, the shoe database 132 is scanned for shoes that have matching attributes (step 224). As can be appreciated, the user 108 may define a certain genre of shoes that he/she prefers and therefore only a portion of the shoe database 132 needs to be searched. The shoes with at least some attributes matching the identified preferences of the user are identified and flagged as a possible shoe the user 108 may enjoy (step 226). Once the shoes have been identified from the shoe database 132 based on their attributes, the user 108 is provided with one or more shoe recommendations (step 228). Thereafter, the user 108 may choose to look specifically at one of the recommended shoes. In step 230 it is determined if the user has selected a shoe to look at for purchase. In the event that the user 108 has selected a particular shoe, the method continues to step 214 and a size recommendation is generated. As can be appreciated by one of skill in the art, the style recommender 120 may work simultaneously with the fit recommender 116 and provide a shoe style and size recommendation to the user 108 at the same time. Then the user 108 only needs to select a recommended shoe and the size recommendation step does not need to be performed again. In the event that the user 108 does not select any shoe or after a shoe size recommendation has been made, the method ends with the user 108 either purchasing the shoe, continuing browsing, or terminating the session with the server 112.

Of course, the user may not know what he/she is browsing for, or may not even be connected to the server 112 in an active web session (i.e., connected to the server 112 directly and actively viewing web content through the server 112). Rather, the user 108 may be provided with periodic email suggesting new shoes based on the user's shoe profile. In the event that the user 108 is not browsing for shoes, it is determined if the user 108 is part of a group of if at least some information is known about the user 108 (this is particularly easy if the user 108 is a subscriber). If no information is known about the user or the user is not part of a group, then the method ends. However, if the user 108 is part of a group or at least some information is known about the user 108, then the style recommender 120 determines attributes that the user 108 may enjoy in a shoe based on the group he/she is a part of or based on the user's shoe profile (step 234). The style recommender 120 scans the user database 156 for shoe profiles of other user's that at least partially match the current user's profile. The users having at least a partially matching profile are identified and their preferred shoe attributes are determined. Also, the style recommender 120 can identify shoes that the matching users currently own and enjoy (or don't enjoy) (step 238). The shoes that have been identified as preferred by other users in the group are provided in a recommendation to the user 108 (step 240). Shoes may be identified as preferred in the event that the one of the users in the group owns the shoe and has provided feedback or has simply provided some positive comments about the shoe. In step 230, it is determined if the user 108 has selected one or more of the recommended shoes. If the user has not selected at least one shoe or the web session has been terminated, the method ends.

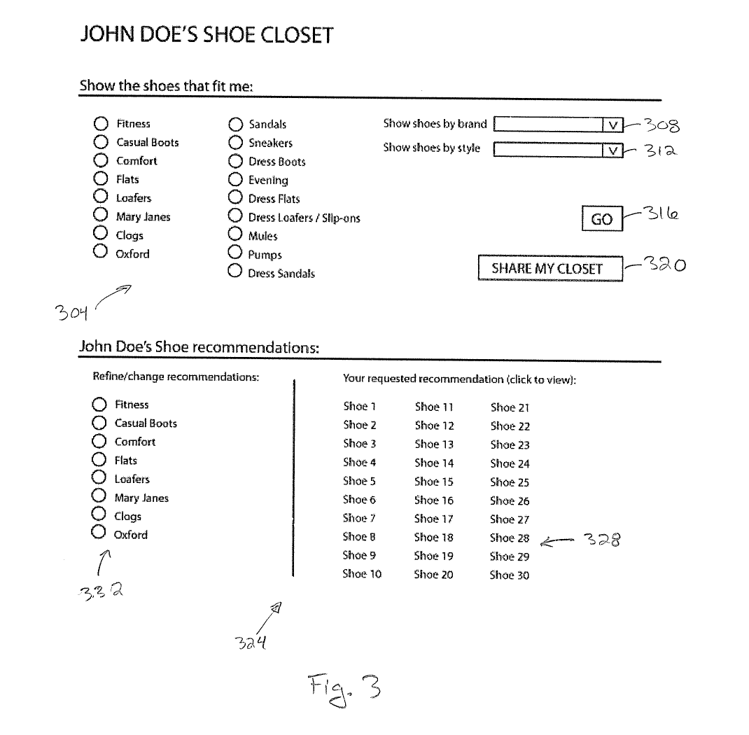

Referring to FIG. 3, an exemplary display of shoe recommendations is shown in accordance with at least some embodiments of the present invention. The displayed selections may include a single shoe featured in relatively larger text and having a relatively larger image with other possible selections illustrated in smaller text or as a smaller image. Each of the shoe recommendation(s) provided to the user preferably will fit or substantially fit the user's feet. Ordering information and product information may be provided adjacent an image of the shoe, for example. Further, if ordering, the user may select the desired shoe style, color, and size, and proceed to a checkout station as is known in the art.

More specifically, the recommendation may comprise a user input section 304, where the user 108 can refine search/recommendation parameters including shoe type and the like. The user input section 304 may also include a brand selector 308 and style selector 312 to help refine the recommendations. These particular selectors are useful, especially if the user 108 has been provided with a large number of shoe recommendations that would take too long to sort through. The recommendation may further comprise a recommendation section 324 including a list of recommended shoes 328 and a list of the styles of recommended shoes 332. The list of styles of recommended shoes 332 may include selection buttons that can further refine the current recommendations. The user inputs 304 generally function to change the scope of the recommendation (i.e., broaden or change search parameters), whereas the selection buttons on the list of styles simply focuses the current recommendations without adding new recommendations.

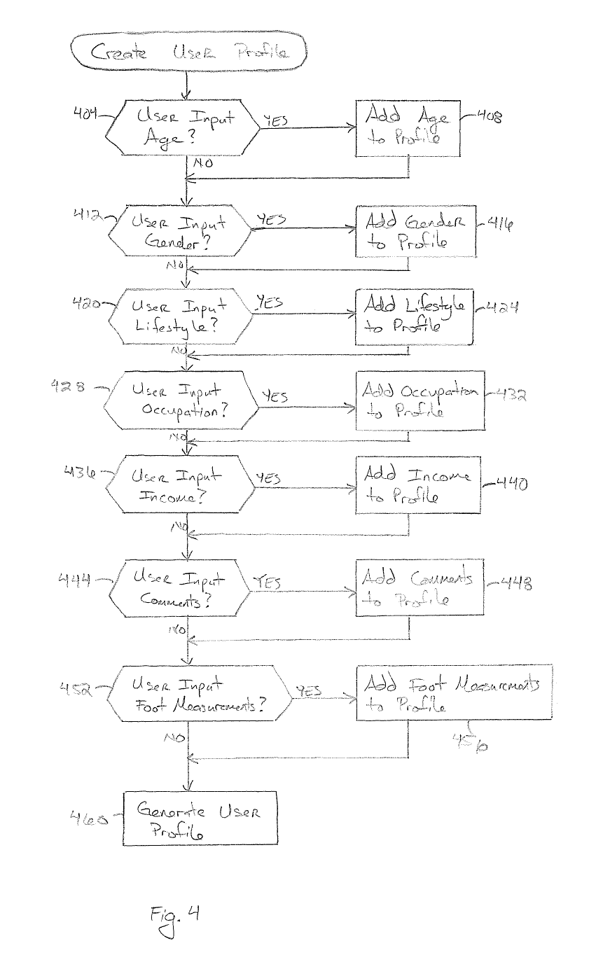

With reference now to FIG. 4, a method of creating a user profile will be described in accordance with at least some embodiments of the present invention. It can be appreciated that a user 108 can provide as much or as little information as desired to create a user profile. Of course, the more information that is available in the user profile, the more likely an accurate recommendation of shoe and shoe size will be made. The method begins, and the user is allowed to input their age (step 404). In the event that the user 108 chooses to enter their age, age is added to the user profile (step 408). Age may be added to the profile in the form of a birthday, such that the user profile automatically updates itself upon the occurrence of the user's 108 birthday. The user 108 is also allowed to input their gender (step 412). In the event that the user 108 inputs their gender, gender is added to the user profile (step 416). The user 108 is further asked questions about their lifestyle (step 420). If the user 108 chooses to answer any lifestyle questions, lifestyle information is added to the user's profile (step 424). Also, the user 108 may be asked about his/her occupation (step 428). Any information input regarding the user's occupation is added to the user's profile (step 432). Related to the occupation, the user may be asked about their income or expendable income (step 436). In the event that the user 108 provides the server 112 with income information, it is added to the user's profile (step 440). As can be appreciated by one of skill in the art, age, gender, lifestyle, occupation, and income are not the only parameters that can be added to a user profile. Other examples of parameters that may be useful in a user profile include weight, health conditions, or similar factors that may have an effect on shoe recommendations. For example, a user with diabetes may only be given recommendations for shoes that are designed for comfort, thus the user will not be recommended shoes that may harm the user's foot.

The method continues when the user 108 is allowed to input other comments (step 444). In the event that the user 108 enters comments, the comments are added to the user's profile (step 448). Another important factor that should be added to a user's profile is the user's foot measurements. The user 108 is allowed to enter his/her foot measurements (i.e., length, width, arch issues, and the like) (step 452). If the user 108 enters foot measurements, the foot measurements are added to the profile (step 456). In one embodiment of the present invention, historical foot measurements for a particular user may be tracked and a future size can be projected. For example, a growing child is not likely to have the same foot size for an extended period of time. As foot measurements are updated, the server 112 may extrapolate foot size for a couple of months in the future and provide a shoe recommendation based on both the child's current foot size and the estimated size of the child's foot. This could allow a parent to purchase a shoe for a child for his/her birthday, for example, and give them the purchased shoe on their birthday. Once the user 108 has entered the desired information into the system, a user profile is generated and stored in the user database 156 (step 460).

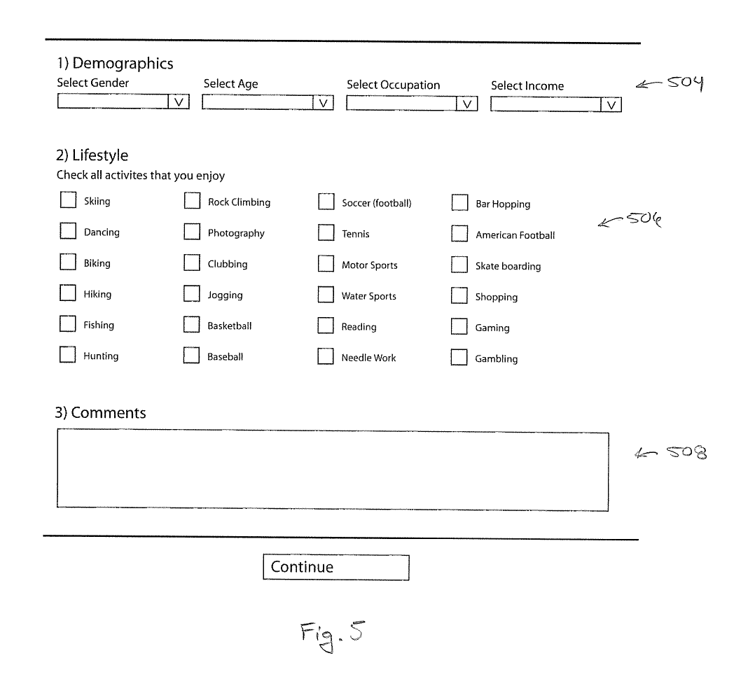

Referring now to FIG. 5 a user interface for inputting user information is shown in accordance with at least some embodiments of the present invention. The user interface comprises a demographics/section 504 where information like gender, age, occupation, income, weight, and so on can be entered. Selecting a predefined parameter from a drop down menu, the user 108 may enter the demographic information. In an alternative embodiment, the user 108 may type any response into the demographics section 504. The user interface may also comprise a lifestyle section 506 where a user can select various activities that they enjoy. Based on the selected activities, a user lifestyle may be determined by the server 112. Additionally, the user interface may include a comments section 508 where a user 108 is allowed to input any additional comments that could not otherwise be input in the previous sections. The biographical information retrieved may be used as a part of the user's profile and may further be used to associate the user with other users having some common attributes. For example, users may be grouped according to occupation and shoe recommendations may be created for the entire group based on feedback received from a portion of the group.

An individual may be requested to provide biographical data to aid in providing an appropriate shoe recommendation by inputting the information into any suitable input device known in the art, such as a keyboard or mouse, in communication with a suitable computing device known in the art. The biographical data may include any selectable information to aid in the selection of a desirable shoe for the user, for example, gender, age, weight, height, occupation, income, and lifestyle activities. The lifestyle activities may include whether, for example, the individuals enjoys skiing, dancing, biking, hiking, fishing, hunting, rock climbing, photography, clubbing, jogging, basketball, baseball, soccer, football, tennis, motor sports, water sports, reading, needle work, bar hopping, skateboarding, shopping, gaming, or gambling. Further, the biographical data may include how the individual would normally describe their shoe size (e.g. U.S. men's size 10.5, thin or medium width, low arch, high arch, etc.). In one embodiment, for example, a runner may provide how many miles he or she runs per week, whether he or she pronates or supinates, and/or his or her weight and height in the comments section 508. This information may be used to help provide a shoe recommendation for the user that fits the user's needs and lifestyle.

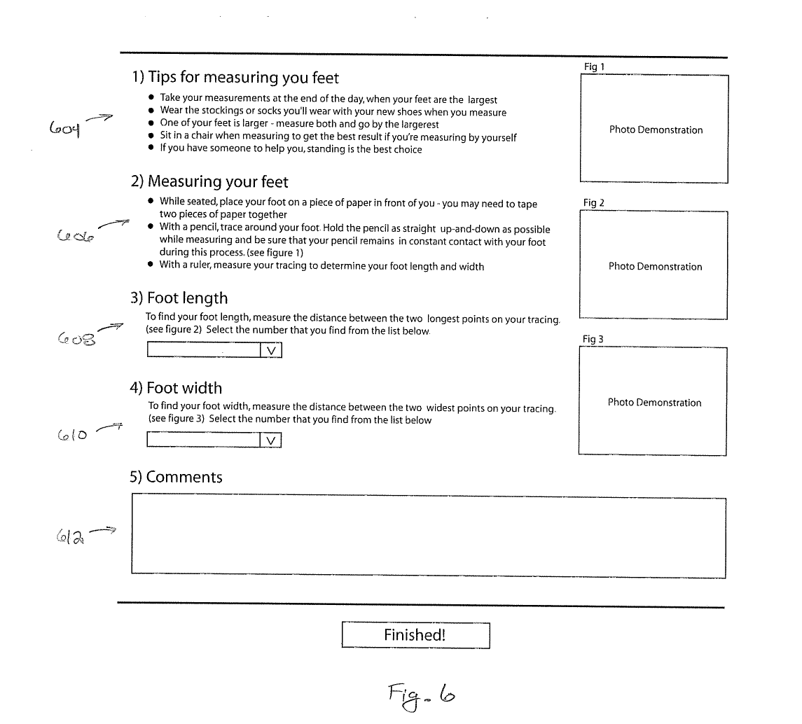

Referring now to FIG. 6, the user interface for assisting a user in measuring his/her foot will be described in accordance with at least some embodiments of the present invention. The foot measurement interface may comprise a tips section 604, a directions section 606, a foot length input section 608, a foot width input section 610, and a comments section 612. To obtain foot measurement data, in one embodiment, the present invention comprises a downloadable and printable template to aid one in measuring various aspects of his or her feet. The downloadable template may include instructions for tracing an outline of each foot onto a piece of paper or other substrate using any suitable writing utensil. Thereafter, the user 108 may measure the length and width of each foot using a ruler, or any other suitable measurement device. Once measured, the data may be provided to the server 112 in the foot length input section 608 and foot width input section 610, helping complete a more accurate profile of the user's feet. The measurement data is generally integrated with the other information provided in the individual's shoe profile. The types of comments that could be useful in the comments section 612 may include whether the user's big toe is longer than the second toe or whether the user has any foot problems (i.e., they are prone to blisters on certain regions of their feet).

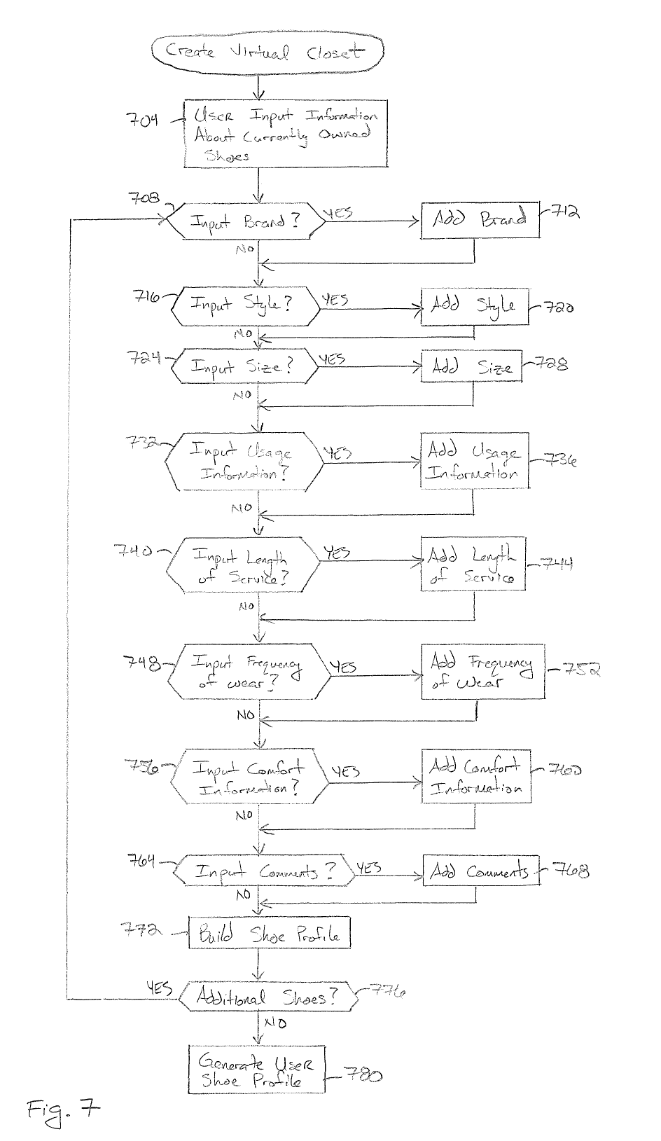

Referring now to FIG. 7 a method of creating a virtual closet of shoes will be described in accordance with at least some embodiments of the present invention. Initially, a user 108 decides to input information about currently owned shoes (step 704). The user may have purchased a portion of the shoes from the online vendor administering the virtual closet questionnaire. Another portion of shoes may have been purchased from a brick and mortar store. Some information may already be available for shoes that were purchased from the online vendor and thus fewer questions may be asked regarding those shoes. In the event that no information is available for the shoes, the user is asked to input brand information for the shoe (step 708). If the user knows and chooses to input brand information, the brand is added to the current shoe profile (step 712). Thereafter, the user may be asked about style information related to the shoe (step 716). Any input style information is added to the shoe profile, thereby increasing the description of the shoe in the virtual closet (step 720). A user may also be asked about the size of the shoe (step 724). If the user inputs the shoe size, it is added to the shoe profile (step 728). The user may further be asked about usage information (e.g., what is the shoe's primary purpose, what is the shoe's secondary purpose) (step 732). An example of an answer to usage questions could be the shoe is mainly used for running and secondarily used for yard work or the shoe was used for camping. Any usage information input is added to the shoe profile (step 736). Another question that may be asked about a shoe is how long it has been in service (i.e., how long has the user owned the shoe) (step 740). In the event that the user inputs length of service information, that information is added to the shoe profile (step 744). A further question that may be asked could relate to the frequency of wear for the shoe (step 748). The user 108 may answer, for example, daily, weekly, bi-weekly, monthly, twice a year, etc. Any answer the user 108 provides related to the frequency of use is input into the shoe profile (step 752). Additionally, the user 108 may be asked about the shoe's comfort (step 756). If the user 108 chooses to answer the comfort question, the response is added to the shoe profile (step 760). Furthermore, the user may be asked to insert any other comments related to the shoe (step 764). Those comments are stored and maintained as a part of the shoe profile as well for the user 108 (step 768). The description of shoes is used to create a shoe profile that gives a relatively accurate portrayal of the user and his/her shoe collection.

In step 776 it is determined if the user 108 has additional shoes that he/she would like to add to supplement his/her shoe profile. In the event that the user 108 has more shoes that he/she would like to add to his/her virtual closet, the method returns to step 708. After the user 108 is finished inputting information related to shoes they actually own, the user shoe profile is generated (step 780).

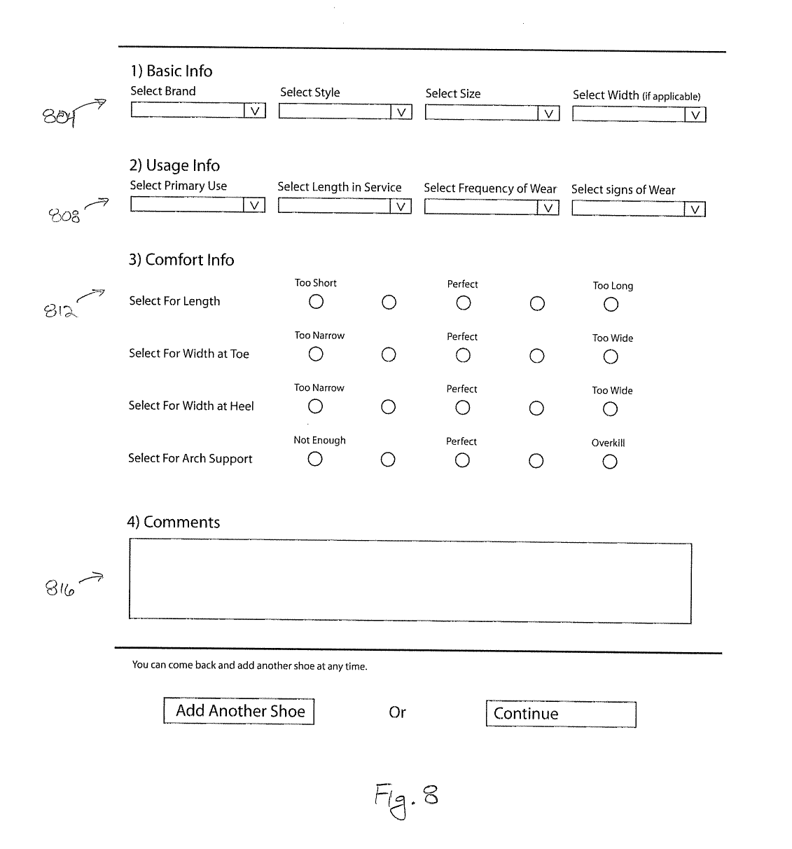

FIG. 8 depicts a user interface for inputting shoe information to aid in creating a virtual closet. The virtual closet user interface comprises a basic shoe information section 804, a usage information section 808, a comfort information section 812, and a comments section 816. The user 108 may be requested to provide a history of shoes currently and/or previously worn to create a snapshot of the size and type of shoes that fit best for the individual. Such historical information may include the brand, style, size, and width of the shoe worn by the individual. Further, the individual may be requested to provide increasingly specific information as to the fit of the shoe, such as, for example:

whether the length of the shoe was too short, perfect, or too long;

whether the toe width was too narrow, perfect, or too wide;

whether the heel cup of the shoe was too narrow, perfect, or too wide;

whether the heel cup of the shoe was too high, perfect, or too low; or

whether the arch support was inadequate, perfect, or too adequate;

whether the arch support placement was too far forward, perfect, or too far backward.

Other suitable information may include the shoe's wear over time, frequency of wear, length of wear, style, general comfort, and shoe use. The individual customer can provide as much or as little info as possible for each pair of shoes and may input or otherwise provide testimonials for each pair of shoes. In one embodiment, the shoe profile is stored in the user database 156 as a virtual shoe profile for online access by the individual user. The inputs may comprise drop down menus with predefined answers or radio buttons corresponding to a rating system. As a further alternative, an input space may be provided wherein a user can type or prepare any response rather than choosing a predetermined response.

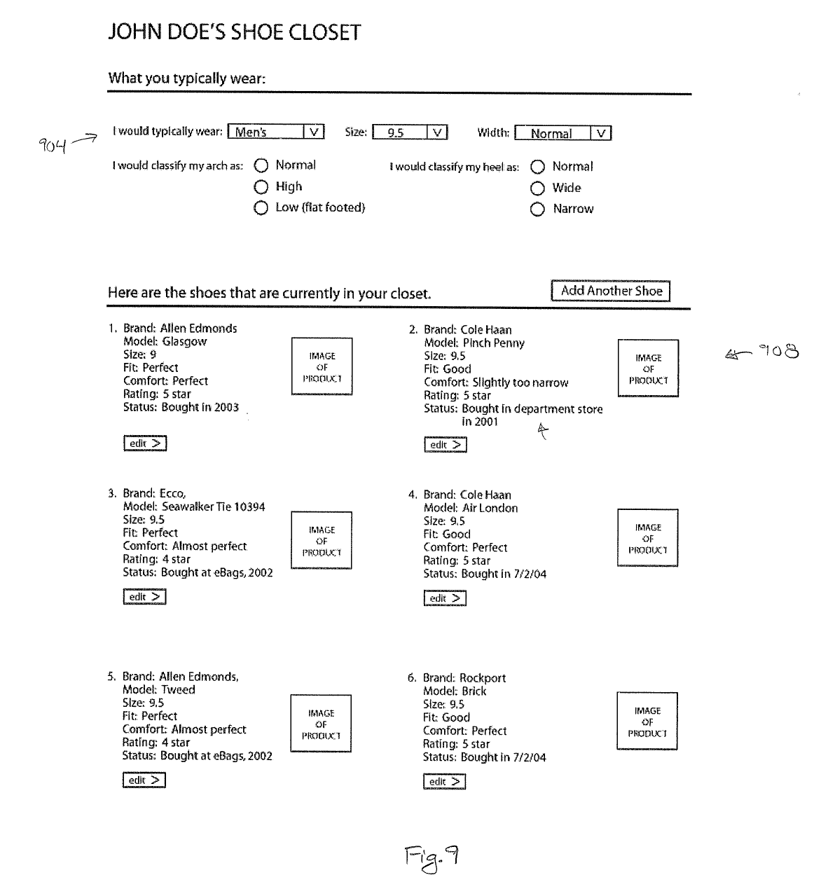

FIG. 9 depicts completed user shoe profile in accordance with at least some embodiments of the present invention. Once all the data, i.e. the individual's biographical data, shoe history, and/or foot measurements are obtained, a current shoe profile is compiled. In an online environment, the virtual shoe profile may be completely displayed for the user, as shown in FIG. 9.

The shoe profile may comprise a classification section 904 that shows the user's foot classification and possibly biographical information and a virtual closet section 908. The virtual closet section 908 is populated as the user purchases more shoes and enters the requisite information. In one embodiment, the virtual closet section 908 is automatically populated when the user purchases a shoe through the online vendor.

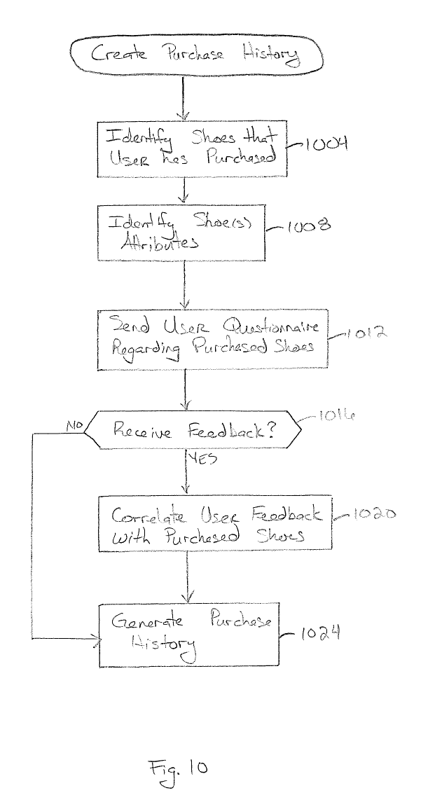

Referring now to FIG. 10, a method of creating a purchase history for shoes will be described in accordance with at least some embodiments of the present invention. More specifically, the purchase history may be for shoes that have been purchased through a particular online vendor. Alternatively, purchase history may be created for shoes that have been purchased in a brick and mortar store. The method begins by identifying shoes that a particular user has purchased (step 1004). This particular step may be performed every time a new pair of shoes is purchased or on a periodic basis. Thereafter, the attributes of the shoe are determined (step 1008). Typical attributes of a shoe include the shoe's inner dimensions, suggested uses, materials, and style. The user 108 who purchased the shoes is then sent a questionnaire regarding their satisfaction or lack thereof with the purchased shoe (step 1012). The questionnaire may include questions related to how well the shoe fit, if the user liked the style, and if the shoe performs its functions well.

In step 1016 it is determined if the user 108 has provided feedback by answering any questions in the questionnaire. In the event that the user 108 has provided at least some feedback, the user's feedback is correlated with the purchased shoe, thereby increasing the amount of information available for the shoe in the shoe profile (step 1020). Thereafter, the purchase history for the user is generated (step 1024). If the user 108 provided feedback, then the feedback may be included as a part of the purchase history. However, in the event that no feedback was provided, the purchase history will contain at least the type of shoe that was purchased by the user.

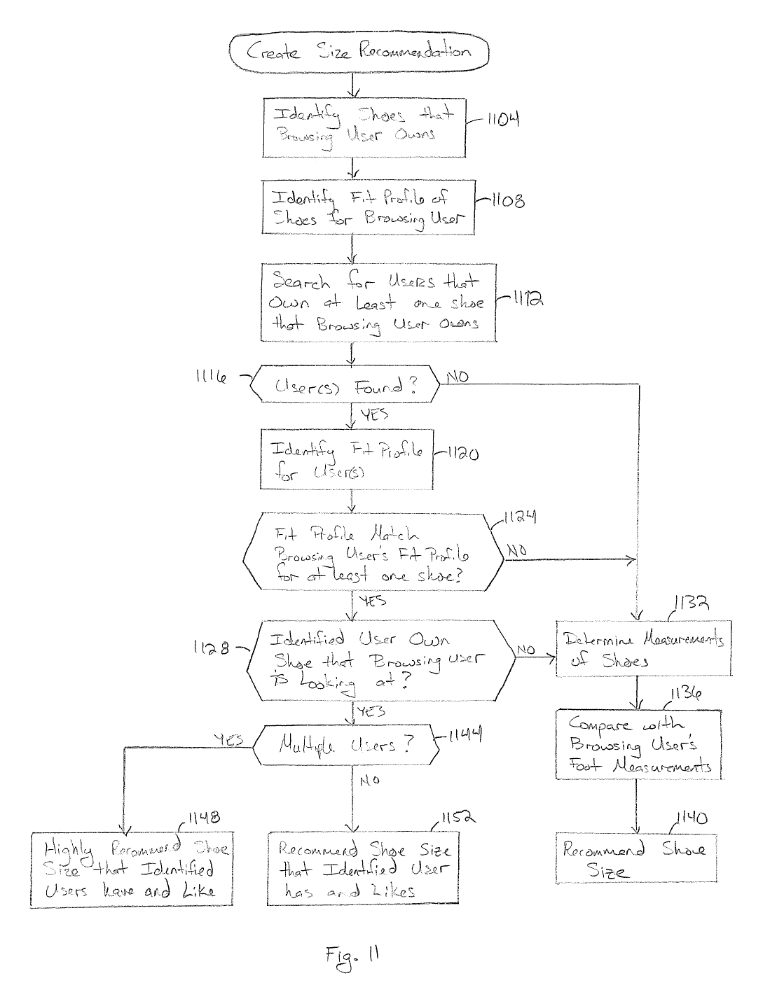

FIG. 11 depicts a method of creating a size recommendation for a particular shoe in accordance with at least some embodiments of the present invention. Initially, shoes that a browsing user owns are identified (step 1104). In other words, the shoe profile for the browsing user, including aspects of the user's virtual shoe closet, are retrieved from the customer database 156. Thereafter, the fit profile for the user is identified from the shoe profile (step 1108). The fit profile for a user includes what size of shoe the user 108 typically wears (i.e., width and/or length) and what style he/she wears those sizes in. The user database 156 is then searched for other users that own at least one pair of shoes that the browsing user owns (step 1112). In a preferred embodiment, the user database 156 is searched for users that have purchased or otherwise own the exact shoe that the browsing user owns (i.e., same size, style, brand, etc.). If the exact same shoe can be found in common between at least one user and the browsing user and comments relating to the fit of the exact same shoe are substantially the same between the user and the browsing user, then other shoe recommendations for the browsing user can be made based upon shoes that the identified user owns.

In step 1 116 it is determined if there are any such users that own at least one pair of shoes in common with the browsing user. As noted above, the user may own the same size and style as the browsing user or, in one embodiment, a size relatively close to the size of the shoe the browsing user owns. If at least one user is found, the fit profile for the identified user is determined (step 1120). The fit profile for the identified user may be based upon feedback by the identified user related to various shoes he/she owns. Thereafter, it is determined if the identified user's fit profile at least partially matches the fit profile of the browsing user (step 1124). For instance, if the identified user and browsing user have the same length of foot, but not the same width they may be determined to have a similar fit profile but only for certain types of shoes. If the identified user and browsing user have at least a partial match in their fit profile, then it is determined if the identified user owns the shoe that the browsing user is looking at or at least a similar shoe (step 1128). In the event that one of the following is true (i) no identified user owns the shoe that the browsing user is looking at, (ii) no user has a fit profile matching the browsing user's fit profile, or (iii) no user was identified as owning a shoe that the browsing user owns, then the fit recommender 116 will recommend a shoe based on the physical dimensions of the shoe and the measured dimensions of the user's foot. In this case, the measurements of the shoe the user is looking at are determined (step 1132). Thereafter, the measurements of the shoe are compared with the user's foot measurements (step 1136). Then a shoe size is recommended based on the comparison between the foot measurements and the size of the shoe (step 1140).

On the other hand, if the three tests identified are passed, then the fit recommender 116 can make a size recommendation based upon information available from other users. In step 1144, it is determined if multiple users having similar fit profiles to the browsing user own the shoe that the browsing user is looking at. If there exist multiple users that fit this description, then the fit recommender 112 highly recommends a shoe size that the identified users have and like (step 1148). If there is only one user (or a relatively small amount of users) that has a fit profile matching the browsing user and owns the shoe that the browsing user is viewing, then a shoe size is recommended for the browsing user with a lower confidence (step 1152).

In so providing a shoe recommendation that corresponds to the shoe profile of the individual, the present invention comprises an algorithm that aggregates shoe profiles from more than one individual and actual physical shoe size data for shoes on the market from a variety of manufacturers to provide at least one shoe recommendation that corresponds to the shoe profile of a particular individual. In particular, a plurality of shoe profiles and known shoe measurements are incorporated into the algorithm to provide a suggested shoe size for a particular user. In providing the recommendations, the algorithm factors data specifying how particular sizes and styles of shoes fit different individuals with similar shoe profiles to determine a recommended shoe (including size and style) for a particular individual. The resulting shoe recommendations may include a confidence rating based on the likelihood that the shoe will fit the individual and the number of comparisons that were used to create the recommendation. A recommendation based on only one comparison of shoe profiles may not have a high confidence rating whereas a recommendation based on comparing multiple similar shoe profiles has a higher confidence rating.

It is contemplated that the algorithm may continuously be modified by soliciting feedback on the accuracy of the shoe fit recommendations. Such feedback may provide a continuous mechanism to help perfect the fit recommendation algorithms, as well as vary the weighted importance of the different data inputs.

It is contemplated that when recommending a shoe to an individual based on his or her shoe profile, each individual may also be provided with shoe recommendations for shoe styles based upon other users with the same or similar tastes and/or shoe sizes. Furthermore, the individual may be provided with a completely different or modified list by changing desired shoe parameters, such as style and shoe use (i.e., athletic, dance, fashion, dress).

Further, one or more recommended shoes may be provided to the user by compiling data for the user's community, such as town, city, county, or state, which contemplates the community's taste, sizing, and ratings. For example, customer's might be grouped into a ‘wide foot’ or ‘active running’ club with discussion groups, suggestions, etc.

The foregoing discussion of the invention has been presented for purposes of illustration and description. Furthermore, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best modes presently known of practicing the invention and to enable others skilled in the art to utilize the invention in such, or in other embodiments, and with the various modifications required by their particular application or use of the invention. It is intended that the appended claims be construed to include alternative embodiments to the extent permitted by the prior art.

1. A method of creating a shoe recommendation, comprising:
obtaining a shoe profile about an individual;
searching a database of shoes and their associated attributes;
comparing said shoe profile to said attributes of at least a portion of shoes in said database; and
providing at least one shoe recommendation to the individual based on said comparing step.

2. The method of claim 1, wherein said providing at least one shoe recommendation which corresponds to the shoe profile of the individual comprises providing an algorithm that aggregates shoe profiles from more than one individual and physical shoe size data to provide at least one shoe recommendation that corresponds to the shoe profile of the individual.

3. The method of claim 1, wherein said obtaining a shoe profile comprises determining at least one of said individual's biographical information, a list of shoes owned by said individual, and measurements of said individual's foot.

4. The method of claim 3, wherein said shoe profile comprises a list of shoes owned by said individual, further comprising:
requesting information related to a brand of at least one shoe owned by said individual;
requesting information related to a style of at least one shoe owned by said individual; and
requesting feedback about at least one shoe owned by said individual.

5. The method of claim 1, further comprising:
comparing said shoe profile of said individual to a shoe profile of at least one other user;
determining that said shoe profile of said individual at least partially matches said shoe profile of said at least one other user;
determining that said at least one other user owns and has commented on a shoe that said individual is viewing; and
providing said individual said user's comments.

6. A computer readable medium comprising executable instructions operable to perform the method of claim 1.

7. A system for creating a shoe recommendation, comprising:
a shoe database containing information related to shoes and their associated attributes;
a user database containing information related to users and their associated shoe profiles; and
a server operable to obtain a shoe profile about an individual from said user database, search at least a portion of said shoe database, compare a shoe profile of an individual to said attributes of at least a portion of shoes in said shoe database, and provide at least one shoe recommendation for said individual based on said comparison of said shoe profile and said shoe attributes.

8. The system of claim 7, wherein the shoe database and user database are associated with a common database.

9. The system of claim 7, wherein the shoe database and user database are associated with different databases.

10. The method of claim 1, further comprising:
determining that said individual is part of group, wherein the group has similar shoe preferences;
determining shoe attributes that said group enjoys;
identifying at least one pair of shoes having said determined shoe attributes; and
providing said individual with a recommendation to purchase said at least one pair of shoes.

11. The method of claim 1, further comprising:
allowing said individual to browse a database of shoes;
said individual selecting a type of shoe from said database of shoes;
comparing attributes of said selected type of shoes to said shoe profile of said individual;
identifying a size of said selected type of shoes that will likely fit said individual based on comparing attributes of said selected type of shoes to said shoe profile; and
providing said individual with a size recommendation for said selected type of shoes.

12. The method of claim 1, wherein said shoe profile comprises information relating to at least one of the following:
said individual's age;
said individual's gender;
said individual's lifestyle;
said individual's occupation;
said individual's weight;
said individual's income; and
said individual's foot measurements.

13. The method of claim 1, further comprising providing said individual with foot size measurement instructions.

14. The system of claim 7, wherein said server further comprises a style recommender that is operable to analyze a first shoe profile of a first user in said user database and compare said first shoe profile with a second shoe profile of a second user, determine the first shoe profile is similar to said second shoe profile, and provide recommendations to said first user based on shoes owned by said second user.

15. The system of claim 7, wherein data stored in said shoe database comprises at least one of shoe make information, shoe style information, shoe measurement information, owner information, and preference information.

16. The system of claim 7, wherein data stored in said user database comprises at least one of user age, user gender, user lifestyle, user occupation, user income, user comments, user foot measurements, user purchase history, shoes owned by user, and fit information.

17. The system of claim 7, wherein the server further comprises a clustering agent that is operable to categorize users into groups based on said users' shoe profiles.

18. The system of claim 17, wherein said clustering agent is further operable to determine shoe attributes that a group enjoys, identify at least one pair of shoes having said determined shoe attributes, identify users in said group that do not own said at least one pair of shoes, and provide said user that does not own said at least one pair of shoes with a recommendation to purchase said at least one pair of shoes.

19. The system of claim 17, wherein said clustering agent is further operable to allow users in a group to view a virtual closet of other users in said group.

20. The system of claim 7, further comprising a shoe finder that allows said individual to browse said shoe database for a particular shoe and further provides information related to said particular shoe and its associated attributes to said individual.
